(19) United States
(12) Patent Application Publication
(10) Pub. No.: US 2023/0298374 A1
(43) Pub. Date: Sep. 21, 2023

(54) METHOD AND DEVICE FOR DETERMINING PICTURE WITH TEXTS

(71) Applicant: SHANGHAI MIDU INFORMATION TECHNOLOGY CO., LTD., Shanghai (CN)

(72) Inventors: Ou KONG, Shanghai (CN); Yidong LIU, Shanghai (CN); Jun WANG, Shanghai (CN)

(73) Assignee: SHANGHAI MIDU INFORMATION TECHNOLOGY CO., LTD., Shanghai (CN)

(21) Appl. No.: 18/200,041

(22) Filed: May 22, 2023

Related U.S. Application Data
(63) Continuation of application No. PCT/CN2022/093266, filed on May 17, 2022.

(30) Foreign Application Priority Data
May 21, 2021 (CN) 202110559656.7

(51) Int. Cl. G06V 30/414; G06V 10/771

(52) U.S. Cl. CPC G06V 30/414; G06V 10/771; G06V 2201/07

(57) ABSTRACT

A method and a device for determining a picture with texts are provided. The method includes: acquiring an original picture for determining the picture with the texts; determining the quantity and/or position coordinate information of textboxes in the original picture based on the original picture and a textbox detection network; and determining whether the original picture is the picture with the texts based on the quantity and/or position coordinate information of the textboxes.

### CROSS REFERENCE TO THE RELATED APPLICATIONS

This application is a continuation application of International Application No. PCT/CN2022/093266, filed on May 17, 2022, which is based upon and claims priority to Chinese Patent Application No. 202110559656.7, filed on May 21, 2021, the entire contents of which are incorporated herein by reference.

### TECHNICAL FIELD

The present application relates to the technical field of computers, and particularly relates to a technology for determining a picture with texts.

### BACKGROUND

In prior art, for classifying pictures with texts, it is needed to utilize an algorithm model to judge an input picture and then determine whether the picture is a picture with texts or not. Generally, a model architecture is constructed by using a convolution neural network (CNN) and fully connected (FC) layers. However, for some pictures such as microblog pictures, it is difficult to fit and solve by an existing algorithm model, the features of the pictures are not obvious, which causes great difficulties to model training, resulting in low efficiency of determining the picture with the texts.

### SUMMARY

The present application aims to provide a method and a device for determining a picture with texts.

In one aspect, the present application provides a method for determining a picture with texts, and the method includes the following steps:
acquiring an original picture for determining the picture with the texts;
determining the quantity and/or position coordinate information of textboxes in the original picture based on the original picture and a textbox detection network; and
determining whether the original picture is the picture with the texts based on the quantity and/or position coordinate information of the textboxes.

Further, the determining the quantity and/or position coordinate information of textboxes in the original picture based on the original picture and a textbox detection network includes:
performing preprocessing operation on the original picture to acquire a preprocessed picture corresponding to the original picture; and
inputting the preprocessed picture into the textbox detection network to determine the quantity and position coordinate information of the textboxes in the original picture.

Further, the inputting the preprocessed picture into the textbox detection network to determine the quantity and position coordinate information of the textboxes in the original picture includes:
inputting the preprocessed picture into the textbox detection network and outputting the position coordinate information of each textbox, the position coordinate information including a vertical coordinate and a horizontal coordinate at an upper left corner and a vertical coordinate and a horizontal coordinate at an upper right corner; and
determining the quantity of the textboxes based on the quantity of the position coordinate information.

Further, the determining whether the original picture is the picture with the texts based on the quantity and/or position coordinate information of the textboxes includes:
determining that the original picture is the picture with the texts in a case that the quantity of the textboxes is larger than preset quantity.

Further, the determining whether the original picture is the picture with the texts based on the quantity and/or position coordinate information of the textboxes includes:
determining that the original picture is the picture with the texts in a case that the quantity of the textboxes is not less than two; and
determining whether the original picture is the picture with the texts based on the position coordinate information of the textbox in a case that the quantity of the textboxes is equal to one.

Further, the determining whether the original picture is the picture with the texts based on the position coordinate information of the textbox includes:
determining that the original picture is not the picture with the texts in a case that the position coordinate information of the textbox is at the lower right corner or the center of the picture.

Further, the picture is input to the textbox detection network to be subjected to convolution, batch normalization and activation function operations of preset pixels so as to obtain a first feature map;
2, 2, 6 and 2 separable deep convolution block operations are respectively carried out to obtain a second feature map;
the second feature map is subjected to 2 convolution operations to obtain a third feature map;
the third feature map is subjected to 2 convolution operations to obtain a fourth feature map;
the fourth feature map is subjected to 2 convolution operations to obtain a fifth feature map;
the fifth feature map is subjected to 2 convolution operations to obtain a sixth feature map; and
the third, fourth, fifth and sixth feature maps are respectively subjected to convolution operations of different levels, and all the convolution operation results are treated as the detection result of the textbox detection network.

In another aspect, the present application further provides a device for determining a picture with texts, and the device includes:
a first apparatus configured to acquire an original picture for determining the picture with the texts;
a second apparatus configured to determine the quantity and/or position coordinate information of textboxes in the original picture based on the original picture and a textbox detection network; and
a third apparatus configured to determine whether the original picture is the picture with the texts based on the quantity and/or position coordinate information of the textboxes.

In yet another aspect, the present application further provides a computer-readable medium for storing a computer-readable instruction, and the computer-readable instruction can be executed by a processor to implement the operation of the foregoing method.

Compared with the prior art, the method in the present application includes: acquiring an original picture for determining the picture with the texts; determining the quantity and/or position coordinate information of textboxes in the original picture based on the original picture and a textbox detection network; and determining whether the original picture is the picture with the texts based on the quantity and/or position coordinate information of the textboxes. With the adoption of such mode, whether the original picture is the picture with the texts can be rapidly and conveniently judged, so that the judgment efficiency is improved.

### BRIEF DESCRIPTION OF THE DRAWINGS

Other features, objectives and advantages of the present disclosure will become more apparent by reading the detailed description of non-limiting embodiments with reference to the following accompanying drawings:

FIG. 1 is a flowchart of a method for determining a picture with texts according to one aspect of the present application; and

FIG. 2 is a schematic diagram of a device for determining a picture with texts according to another aspect of the present application.

The same or similar signs in the accompanying drawings represent the same or similar parts.

### DETAILED DESCRIPTION OF THE EMBODIMENTS

The following further describes the present disclosure in detail with reference to the accompanying drawings.

In a typical configuration of the present application, terminals, devices serving the network and trusted parties includes one or more processors (such as CPUs), an input/output interface, a network interface, and an internal memory.

The memory may include a form such as a volatile memory, a random-access memory (RANI) and/or a non-volatile memory such as a read-only memory (ROM) or a flash RAM in a computer-readable medium. The internal memory is an example of the computer-readable medium.

The computer-readable medium includes a non-volatile medium and a volatile medium, a removable medium and a non-removable medium, which may implement storage of information by using any method or technology. The information may be a computer-readable instruction, a data structure, a program module, or other data. Examples of a storage medium of a computer includes, but is not limited to, a phase-change memory (PRAM), a static random access memory (SRAM), a dynamic random access memory (DRAM), or other types of random access memory (RAM), a read-only memory (ROM), an erasable programmable read-only memory (EEPROM), a flash memory or another internal memory technology, a compact disc read-only memory (CD-ROM), a digital versatile disc (DVD) or another optical storage, a cartridge tape, a magnetic tape, a magnetic disk storage or another magnetic storage device, or any other non-transmission medium, which may be configured to store information accessible by a computing device. According to limitations of this specification, the computer-readable medium does not include transitory computer-readable media, such as a modulated data signal and a modulated carrier.

In order to further describe the technical means adopted in the present application and the results achieved, the technical solutions of the present application will be clearly and completely described below in combination with the accompanying drawings and preferred embodiments.

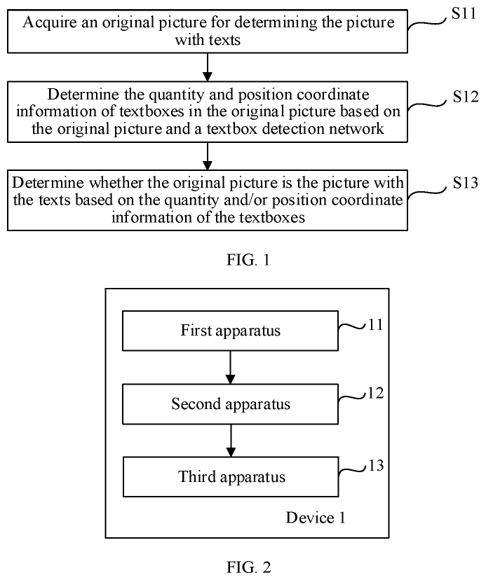

FIG. 1 is a flowchart of a method for determining a picture with texts according to one aspect of the present application. The method is executed on a device 1, and the method includes the following steps:
S11: Acquire an original picture for determining the picture with the texts.
S12: Determine the quantity and/or position coordinate information of textboxes in the original picture based on the original picture and a textbox detection network.
S13: Determine whether the original picture is the picture with the texts based on the quantity and/or position coordinate information of the textboxes.

According to the present application, the device 1 includes but is not limited to a computer, a network host, a single network server, a plurality of network server sets or a cloud composed of a plurality of servers; and the cloud is composed of a large number of computers or network servers based on cloud computing, the cloud computing is one of distributed computing and involves a virtual supercomputer composed of a group of loosely coupled computer sets. The abovementioned device 1 is only taken as an example, other existing or future possible device 1 which can be applied to the present application are included in the protection scope of the present application, and the abovementioned device is included in the protection scope in a reference manner. This solution is suitable for determining whether the original picture is the picture with the texts, and is particularly suitable for determining microblog pictures.

In the embodiment, in step S11, the device 1 acquires the original picture for determining the picture with the texts. The picture with the texts includes a picture which is mostly occupied by the texts or a picture which is completely occupied by the texts; the original picture can be acquired from a microblog or other network platforms; and the manner of acquiring the picture is not limited in this solution.

In the embodiment, in step S12, the quantity and/or position coordinate information of textboxes in the original picture is determined based on the original picture and the textbox detection network. The textbox detection network is used for detecting the position coordinate information of the textboxes of the input picture, so that the original picture can be input to the textbox detection network for detection to determine the position coordinate information of the textboxes in the original picture, and the position coordinate information can include a vertical coordinate and a horizontal coordinate at an upper left corner and a vertical coordinate and a horizontal coordinate at an upper right corner. One textbox can correspond to one row or a preset row of texts.

Preferably, the picture is input to the textbox detection network to be subjected to convolution, batch normalization and activation function operations of preset pixels so as to obtain a first feature map;
2, 2, 6 and 2 separable deep convolution block operations are respectively carried out to obtain a second feature map;
the second feature map is subjected to 2 convolution operations to obtain a third feature map;
the third feature map is subjected to 2 convolution operations to obtain a fourth feature map;
the fourth feature map is subjected to 2 convolution operations to obtain a fifth feature map;
the fifth feature map is subjected to 2 convolution operations to obtain a sixth feature map; and
the third, fourth, fifth and sixth feature maps are respectively subjected to convolution operations of different levels, and all the convolution operation results are treated as the detection result of the textbox detection network.

Preferably, step S12 includes: S121 (not shown): Perform preprocessing operation on the original picture to acquire a preprocessed picture corresponding to the original picture; and S122 (not shown): Input the preprocessed picture into the textbox detection network to determine the quantity and position coordinate information of the textboxes in the original picture.

In the embodiment, the device 1 is configured to preprocess the original picture, and the picture can be preprocessed into a picture with preset pixels or other pictures conforming to the text detection network, and no limitation is made for the specific form of the preprocessing in this solution.

Preferably, step S122 includes: inputting the preprocessed picture into the textbox detection network and outputting the position coordinate information of each textbox, the position coordinate information including a vertical coordinate and a horizontal coordinate at an upper left corner and a vertical coordinate and a horizontal coordinate at an upper right corner; and determining the quantity of the textboxes based on the quantity of the position coordinate information. In the embodiment, the left upper corner of the picture can be used as a coordinate origin, and then the position coordinate information of each textbox is detected through the textbox detection network. One textbox can correspond to a row of texts, or the textboxes can be determined according to a preset rule. Specifically, the quantity of the textboxes can be determined according to the quantity of the output coordinates.

For example, in a preferred embodiment, the determining the position coordinate information of textboxes includes the following steps:
1) inputting an image, and preprocessing into an image of 416*416*3 pixels;
2) performing convolution, batch normalization and activation function operations of 3*3*32 pixels to obtain a feature map (corresponding to the first feature map) of 150*150*64 pixels;
3) performing 2 separable deep convolution block operations to obtain a feature map of 75*75*128 pixels;
4) performing 2 separable deep convolution block operations to obtain a feature map of 38*38*256 pixels;
5) performing 6 separable deep convolution block operations to obtain a feature map of 19*19*512 pixels;
6) performing 2 separable deep convolution block operations to obtain a feature map (corresponding to the second feature map) of 19*19*1024 pixels;
7) performing 2 convolution operations to obtain a feature map (corresponding to the third feature map) of 10*10*512 pixels;
8) performing 2 convolution operations to obtain a feature map (corresponding to the fourth feature map) of 5*5*256 pixels;
9) performing 2 convolution operations to obtain a feature map (corresponding to the fifth feature map) of 3*3*256 pixels;
10) performing 2 convolution operations to obtain a feature map (corresponding to the sixth feature map) of 1*1*256 pixels;
11) performing convolution operations of different levels on the third, fourth, fifth and sixth feature maps respectively, and finally fusing all results to obtain the detection result of the textboxes; and
12) determining the detection result in a format of [[y_left, x_left, y_right, x_right], [ . . . ]]. The y_left and x_left respectively represent the vertical coordinate and the horizontal coordinate at the left upper corner, and the y_right and the x_right respectively represent the vertical coordinate and the horizontal coordinate at the right upper corner.

In the embodiment, step S13 includes determining whether the original picture is the picture with the texts based on the quantity and/or position coordinate information of the textboxes. In this step, whether the original picture is the picture with the texts can be determined based on the quantity, position coordinate information of the textboxes or a combination thereof. Preferably, step S13 includes: determining that the original picture is the picture with the texts in a case that the quantity of the textboxes is larger than preset quantity.

In a preferred embodiment, step S13 includes: determining that the original picture is the picture with the texts in a case that the quantity of the textboxes is not less than two; and determining whether the original picture is the picture with the texts based on the position coordinate information of the textbox in a case that the quantity of the textboxes is equal to one.

Preferably, the determining whether the original picture is the picture with the texts based on the position coordinate information of the textbox includes: determining that the original picture is not the picture with the texts in a case that the position coordinate information of the textbox is at the lower right corner or the center of the picture.

Compared with the prior art, the method in the present application includes: acquiring an original picture for determining the picture with the texts; determining the quantity and/or position coordinate information of textboxes in the original picture based on the original picture and a textbox detection network; and determining whether the original picture is the picture with the texts based on the quantity and/or position coordinate information of the textboxes. With the adoption of such mode, whether the original picture is the picture with the texts can be rapidly and conveniently judged, so that the judgment efficiency is improved.

In addition, an embodiment of the present application further provides a computer-readable medium for storing a computer-readable instruction, and the computer-readable instruction can be executed by a processor to implement the operation of the foregoing method.

An embodiment of the present application further provides a device for determining a picture with texts, and the device includes:
one or more processors; and
a memory storing a computer-readable instruction, and the computer-readable instruction can be executed to enable the processor to implement the operation of the foregoing method.

For example, the computer-readable instruction can be executed to enable the one or more processors to implement the steps of acquiring an original picture for determining the picture with the texts; determining the quantity and/or position coordinate information of textboxes in the original picture based on the original picture and a textbox detection network; and determining whether the original picture is the picture with the texts based on the quantity and/or position coordinate information of the textboxes.

For those skilled in the art, it is obvious that the present disclosure is not limited to the details of the above exemplary embodiments, and can be realized in other specific forms without departing from the spirit or basic features of the present disclosure. Therefore, from any point of view, the embodiments should be regarded as exemplary and non-restrictive. The scope of the present disclosure is limited by the appended claims rather than the above description. Therefore, it is intended to include all changes within the meaning and scope of the equivalent elements of the claims in the present disclosure. No reference numerals in the claims should be considered as limitations to the related claims. In addition, it is clear that the word “comprising” does not exclude other units or steps, and the singular does not exclude the plural. The multiple units or apparatuses stated in the apparatus claim can also be realized by one unit or apparatus through software or hardware. The words such as “first” and “second” are only used to denote names, and do not denote any particular order.

What is claimed is:

1. A method for determining a picture with texts, comprising:
acquiring an original picture for determining the picture with the texts;
determining a quantity and/or position coordinate information of textboxes in the original picture based on the original picture and a textbox detection network; and
determining whether the original picture is the picture with the texts based on the quantity and/or position coordinate information of the textboxes.

2. The method according to claim 1, wherein the step of determining the quantity and/or position coordinate information of the textboxes in the original picture based on the original picture and the textbox detection network comprises:
performing a preprocessing operation on the original picture to acquire a preprocessed picture corresponding to the original picture; and
inputting the preprocessed picture into the textbox detection network to determine the quantity and/or position coordinate information of the textboxes in the original picture.

3. The method according to claim 2, wherein the step of inputting the preprocessed picture into the textbox detection network to determine the quantity and/or position coordinate information of the textboxes in the original picture comprises:
inputting the preprocessed picture into the textbox detection network and outputting the position coordinate information of each of the textboxes, wherein the position coordinate information comprises a vertical coordinate and a horizontal coordinate at an upper left corner and a vertical coordinate and a horizontal coordinate at an upper right corner; and
determining the quantity of the textboxes based on the quantity of the position coordinate information.

4. The method according to claim 1, wherein the step of determining whether the original picture is the picture with the texts based on the quantity and/or position coordinate information of the textboxes comprises:
determining that the original picture is the picture with the texts in a case that the quantity of the textboxes is larger than a preset quantity.

5. The method according to claim 1, wherein the step of determining whether the original picture is the picture with the texts based on the quantity and/or position coordinate information of the textboxes comprises:
determining that the original picture is the picture with the texts in a case that the quantity of the textboxes is larger than or equal to two; and
determining whether the original picture is the picture with the texts based on the position coordinate information of the textbox in a case that the quantity of the textboxes is equal to one.

6. The method according to claim 5, wherein the step of determining whether the original picture is the picture with the texts based on the position coordinate information of the textbox comprises:
determining that the original picture is not the picture with the texts in a case that the position coordinate information of the textbox is at a lower right corner or a center of the picture.

7. The method according to claim 1, wherein the picture is input to the textbox detection network to be subjected to convolution, batch normalization and activation function operations of preset pixels to obtain a first feature map;
2, 2, 6 and 2 separable deep convolution block operations are respectively carried out to obtain a second feature map;
the second feature map is subjected to 2 convolution operations to obtain a third feature map;
the third feature map is subjected to 2 convolution operations to obtain a fourth feature map;
the fourth feature map is subjected to 2 convolution operations to obtain a fifth feature map;
the fifth feature map is subjected to 2 convolution operations to obtain a sixth feature map; and
the third, fourth, fifth and sixth feature maps are respectively subjected to convolution operations of different levels, and all the convolution operation results are treated as a detection result of the textbox detection network.

8. A device for determining a picture with texts, comprising:
a first apparatus configured to acquire an original picture for determining the picture with the texts;
a second apparatus configured to determine a quantity and/or position coordinate information of textboxes in the original picture based on the original picture and a textbox detection network; and
a third apparatus configured to determine whether the original picture is the picture with the texts based on the quantity and/or position coordinate information of the textboxes.

9. A computer-readable medium for storing a computer-readable instruction, wherein the computer-readable instruction is allowed to be executed by a processor to implement the method according to claim 1.

10. A device for constructing a picture training set, comprising:
at least one processor; and
a memory storing a computer-readable instruction, wherein the computer-readable instruction is allowed to be executed to enable the at least one processor to implement the operation of the method according to claim 1.

11. The method according to claim 2, wherein the step of determining whether the original picture is the picture with the texts based on the quantity and/or position coordinate information of the textboxes comprises:
determining that the original picture is the picture with the texts in a case that the quantity of the textboxes is larger than a preset quantity.

12. The method according to claim 3, wherein the step of determining whether the original picture is the picture with the texts based on the quantity and/or position coordinate information of the textboxes comprises:
determining that the original picture is the picture with the texts in a case that the quantity of the textboxes is larger than a preset quantity.

13. The method according to claim 2, wherein the step of determining whether the original picture is the picture with the texts based on the quantity and/or position coordinate information of the textboxes comprises:
determining that the original picture is the picture with the texts in a case that the quantity of the textboxes is larger than or equal to two; and
determining whether the original picture is the picture with the texts based on the position coordinate information of the textbox in a case that the quantity of the textboxes is equal to one.

14. The method according to claim 3, wherein the step of determining whether the original picture is the picture with the texts based on the quantity and/or position coordinate information of the textboxes comprises:
determining that the original picture is the picture with the texts in a case that the quantity of the textboxes is larger than or equal to two; and
determining whether the original picture is the picture with the texts based on the position coordinate information of the textbox in a case that the quantity of the textboxes is equal to one.

15. The computer-readable medium according to claim 9, wherein in the method, the step of determining the quantity and/or position coordinate information of the textboxes in the original picture based on the original picture and the textbox detection network comprises:
performing a preprocessing operation on the original picture to acquire a preprocessed picture corresponding to the original picture; and
inputting the preprocessed picture into the textbox detection network to determine the quantity and/or position coordinate information of the textboxes in the original picture.

16. The computer-readable medium according to claim 15, wherein in the method, the step of inputting the preprocessed picture into the textbox detection network to determine the quantity and/or position coordinate information of the textboxes in the original picture comprises:
inputting the preprocessed picture into the textbox detection network and outputting the position coordinate information of each of the textboxes, wherein the position coordinate information comprises a vertical coordinate and a horizontal coordinate at an upper left corner and a vertical coordinate and a horizontal coordinate at an upper right corner; and
determining the quantity of the textboxes based on the quantity of the position coordinate information.

17. The computer-readable medium according to claim 9, wherein in the method, the step of determining whether the original picture is the picture with the texts based on the quantity and/or position coordinate information of the textboxes comprises:
determining that the original picture is the picture with the texts in a case that the quantity of the textboxes is larger than a preset quantity.

18. The computer-readable medium according to claim 9, wherein in the method, the step of determining whether the original picture is the picture with the texts based on the quantity and/or position coordinate information of the textboxes comprises:
determining that the original picture is the picture with the texts in a case that the quantity of the textboxes is larger than or equal to two; and
determining whether the original picture is the picture with the texts based on the position coordinate information of the textbox in a case that the quantity of the textboxes is equal to one.

19. The computer-readable medium according to claim 18, wherein in the method, the step of determining whether the original picture is the picture with the texts based on the position coordinate information of the textbox comprises:
determining that the original picture is not the picture with the texts in a case that the position coordinate information of the textbox is at a lower right corner or a center of the picture.

20. The computer-readable medium according to claim 9, wherein in the method, the picture is input to the textbox detection network to be subjected to convolution, batch normalization and activation function operations of preset pixels to obtain a first feature map;
2, 2, 6 and 2 separable deep convolution block operations are respectively carried out to obtain a second feature map;
the second feature map is subjected to 2 convolution operations to obtain a third feature map;
the third feature map is subjected to 2 convolution operations to obtain a fourth feature map;
the fourth feature map is subjected to 2 convolution operations to obtain a fifth feature map;
the fifth feature map is subjected to 2 convolution operations to obtain a sixth feature map; and
the third, fourth, fifth and sixth feature maps are respectively subjected to convolution operations of different levels, and all the convolution operation results are treated as a detection result of the textbox detection network.
